(19) United States
(12) Patent Application Publication
(10) Pub. No.: US 2015/0075121 A1
(43) Pub. Date: Mar. 19, 2015

(54) MULTI-MODE AIR FILTER FOR MOTORCYCLES OR OTHER VEHICLES

(71) Applicant: Two Brothers Racing, Inc., Santa Ana, CA (US)

(72) Inventors: Bernhard Leitner, Mission Viejo, CA (US); Craig Erion, Lemon Heights, CA (US); Jeff Whitten, Santa Ana, CA (US)

(21) Appl. No.: 14/485,317

(22) Filed: Sep. 12, 2014

Related U.S. Application Data
(60) Provisional application No. 61/877,841, filed on Sep. 13, 2013.
(60) Provisional application No. 61/891,325, filed on Oct. 15, 2013.

(51) Int. Cl. F02M 35/08; F02M 35/024

(52) U.S. Cl. CPC F02M 35/082; F02M 35/02416
USPC 55/309

(57) ABSTRACT

An air filter system for a vehicle includes a housing defining an opening to an intake system of the vehicle. A filter element is supported within the housing and positioned upstream from the opening relative to a flow of intake air to the intake system. A bypass channel selectively permits intake air to pass through the opening without passing through the filter element. A closure selectively closes the bypass channel.

### INCORPORATION BY REFERENCE TO ANY PRIORITY APPLICATIONS

This application claims the benefit of U.S. Provisional Patent Application Nos. 61/877841, filed Sep. 13, 2013, entitled “MULTI-MODE AIR FILTER FOR MOTORCYCLES OR OTHER VEHICLES,” and 61/891325, filed Oct. 15, 2013, entitled “MULTI-MODE AIR FILTER FOR MOTORCYCLES OR OTHER VEHICLES.”This application hereby incorporates by reference the above-identified applications in their entireties.

### BACKGROUND OF THE INVENTION

1. Field of the Invention

The present invention relates to air filters for vehicles, such as motorcycles, for example. In particular, the present invention relates to dual mode air filters for such vehicles.

2. Description of the Related Art

Motorcycles and other similar vehicles incorporating internal combustion engines typically incorporate an air filter arrangement to filter particulate from air that is to be supplied to the intake system and, ultimately, the combustion chamber of the engine. The removal of particulate from the intake air reduces wear and increases the life of the engine. However, many air filters designed for regular use, while providing satisfactory filtering performance, also increase resistance to airflow and, thus, reduce the power output of the engine relative to its potential output. Therefore, for racing or other high performance applications, filter designs are often utilized that improve airflow, but provide little or no effective filtering.

### SUMMARY OF THE INVENTION

An aspect of the present invention involves the realization that the same vehicle may be exposed to both normal use and high-performance or racing use and that it would be advantageous to have an air filter system that is adjustable between at least two modes of use. In some configurations, the air filter system can be adjusted between at least two modes of use quickly and/or without any or without significant disassembly or removal of the system components.

The systems, methods and devices described herein have innovative aspects, no single one of which is indispensable or solely responsible for their desirable attributes. Without limiting the scope of the claims, some of the advantageous features will now be summarized.

An embodiment involves an air filter system for a vehicle includes a housing defining an opening to an intake system of the vehicle. A filter element is supported within the housing and positioned upstream from the opening relative to a flow of intake air to the intake system. A bypass channel selectively permits intake air to pass through the opening without passing through the filter element. A closure selectively closes the bypass channel.

In some configurations, the closure comprises a shutter. The shutter can be an iris-type shutter. The shutter can be variably adjustable between an opened position and a closed position. The intake member can surround an opening to the bypass channel. In some configurations, the intake member is movable to adjust a position of the shutter. The intake member can be rotatable.

In some configurations, the closure comprises a plug. The plug can be removed from an opening to the bypass channel and an intake member can be coupled to the opening.

In some configurations, the filter element is annular in shape and is sandwiched between a first plate and a second plate. The bypass channel can extend through the second plate and into an interior space of the filter element.

In some configurations, a screen element extends across the bypass channel.

An embodiment involves an air filter system for a vehicle. The air filter system includes a housing defining an opening to an intake system of the vehicle, a filter element supported within the housing and positioned upstream from the opening relative to a flow of intake air to the intake system, a bypass channel that selectively permits intake air to pass through the opening without passing through the filter element, the bypass channel comprising a first bypass channel portion and a second bypass channel portion parallel to the first bypass channel portion, wherein the intake air passes through only one of the first and second bypass channel portions.

### BRIEF DESCRIPTION OF THE DRAWINGS

Throughout the drawings, reference numbers can be reused to indicate general correspondence between reference elements. The drawings are provided to illustrate example embodiments described herein and are not intended to limit the scope of the disclosure.

FIG. 1 is a front perspective view of an air filter system for a motorcycle or other vehicle having certain features, aspects and advantages of a preferred embodiment. The air filter system is illustrated in a first or normal use mode in FIG. 1 in which all intake air is passed through a filter element.

FIG. 2 is a front perspective view of the dual mode air filter system of FIG. 1 in a second mode in which a portion of the intake air is permitted to pass through a bypass channel that bypasses the filter element.

FIG. 3 is a front perspective view of the dual mode air filter system of FIG. 1 in a third mode in which the bypass channel is fully open.

FIG. 4 is a front perspective view of a modification of the air filter system of FIGS. 1-3. The air filter system of FIG. 4 includes a removable plug that selectively covers the bypass channel.

FIG. 5 is a front perspective view of the air filter system of FIG. 4 with the plug removed and the bypass channel open. An optional tapered inlet or velocity stack is coupled to the inlet of the bypass channel.

FIG. 6 is a front perspective view of a modification of the air filter system of FIGS. 4 and 5.

FIG. 7 is a sectional view of the air filter system of FIG. 6. The air filter system of FIGS. 5 and 6 includes a bypass member that defines at least a substantial entirety of the bypass channel.

FIG. 8 is a front perspective view of another embodiment of an air filter system for a motorcycle or other vehicle.

FIG. 9 is a sectional view of the air filter system of FIG. 8 that includes a removable plug that selectively covers the bypass channel.

FIG. 10 is another sectional view of the air filter system of FIG. 8 with the bypass channel fully open.

### DETAILED DESCRIPTION OF THE PREFERRED EMBODIMENTS

FIGS. 1-3 illustrate an air filter system 10 for a motorcycle or other similar vehicle incorporating an air-using or internal combustion engine. The air filter system 10 can be a multi-mode system that includes at least two operational modes. Preferably, one mode is a first or normal use mode in which all or substantially all intake air is passed through a filter element, such as a foam or paper element, which filters a high level of particulate from the intake air. Another mode is a second, high-performance or racing mode in which at least some intake air bypasses the filter element in a path from upstream of the air filter system 10 to the combustion chamber of the associated vehicle. Preferably, in the second mode, a portion of the intake air passes through a bypass channel that includes a lower level of filtering compared to the filter element. In some configurations, intake air passing through the bypass channel may be unfiltered or substantially unfiltered (e.g., passed through a screen that filters only relatively large objects). The illustrated air filter system 10 of FIGS. 1-3 preferably includes more than two modes of operation, which are described further herein.

The air filter system 10 preferably includes a housing arrangement 12, which can include a first wall 14 and a second wall 16. A filter element 18 (e.g., a foam or paper filter element) is positioned within the housing arrangement 12, such as between the first wall 14 and the second wall 16. In the illustrated arrangement, the first wall 14 is defined by a plate and the second wall 16 is defined by a second plate. The filter element 18 is sandwiched between the first plate 14 and the second plate 16, preferably being sealed against each plate 14, 16. Thus, the filter element 18 forms a side wall of the air filter system 10. Alternatively, the filter element 18 could be contained within a housing arrangement 12 that has distinct side walls. In the illustrated arrangement, the plates 14, 16 are coupled to one another, such as by a plurality of fasteners 20 (e.g., bolts). Optional spacers 22 can be provided to appropriately space the first plate 14 from the second plate 16 to avoid excessive axial forces from being applied to the filter element 18. The first plate 14 can be coupled to an intake system of an associated vehicle (not shown), such as by one or more fasteners 24 (e.g., bolts), preferably in a substantially sealed manner.

The illustrated filter element 18 is generally or substantially annular in shape thereby defining an interior space through which intake air can pass. Intake air can pass through a wall of the filter element 18 from the outside of the air filter system 10 to within the interior space of the filter element 18 and then through an opening in the first plate 14 to the combustion chamber of the engine of the associated vehicle. The wall of the filter element 18 can be of any suitable material(s) or construction. Preferably, the filter element 18 is the same as or similar to other filters used for normal use applications in connection with the particular vehicle with which the present air filter system 10 is intended for use. Such filter elements are often foam or paper (including paper-like materials). The filter wall may be corrugated or pleated to increase surface area.

The air filter system 10 also includes a bypass opening or bypass channel 30 through which intake air can pass from outside the air filter system 10 to the combustion chamber of the engine of the associated vehicle without passing through the filter element 18. In the illustrated arrangement, the bypass channel 30 is at least partially defined by an aperture or opening 32 in the second plate 16, which opens to the interior space of the filter element 18. A tapered inlet or velocity stack 34 can surround the opening 32 and extend outwardly from the second plate 16 to guide intake air through the opening 32 and, preferably, increase a velocity of the intake air as it passes through the velocity stack 34.

The bypass channel 30 or opening 32 can be selectively partially or fully closed by a shutter 40. The illustrated shutter 40 is a multi-component iris or diaphragm type shutter in which multiple shutter leafs or blades move (e.g., pivot) toward or away from a center of the opening 32. However, other suitable types of shutters could also be used (e.g., butterfly type or guillotine type). Preferably, a screen element 50 extends across the opening 32 to inhibit large objects from passing through the bypass channel 30. However, preferably the screen element 50 does not significantly restrict air flow and provides much less “filtering” than the filter element 18. In other words, the screen element 50 preferably is simply a large object deflector through which airflow is at least substantially unrestricted.

In the illustrated arrangement, the shutter 40 is manually-controlled, preferably without requiring the use of tools. For example, the components (e.g., leafs or blades) of the shutter 40 can be coupled for movement with the velocity stack 34 such that rotation of the velocity stack 34 results in movement (e.g., pivoting movement) of the components of the shutter 40 to move the shutter 40 between a closed position and an open position. Any suitable coupling arrangement can be used between the velocity stack 34 and the components of the shutter 40, such as a pin-in-slot or groove arrangement, for example and without limitation. The velocity stack 34 can have detent positions relative to the housing 16 or can be infinitely adjustable. In some arrangements, the shutter 40 is positionable (at least securely) in only a fully opened or a fully closed position. In other arrangements, such as the illustrated arrangement, the shutter 40 is variable such that it can be positioned for use in one or more positions between fully opened and fully closed. In other arrangements, a control mechanism other than the velocity stack 34 can be used to control a position of the shutter 40, such as a separate dial, for example and without limitation.

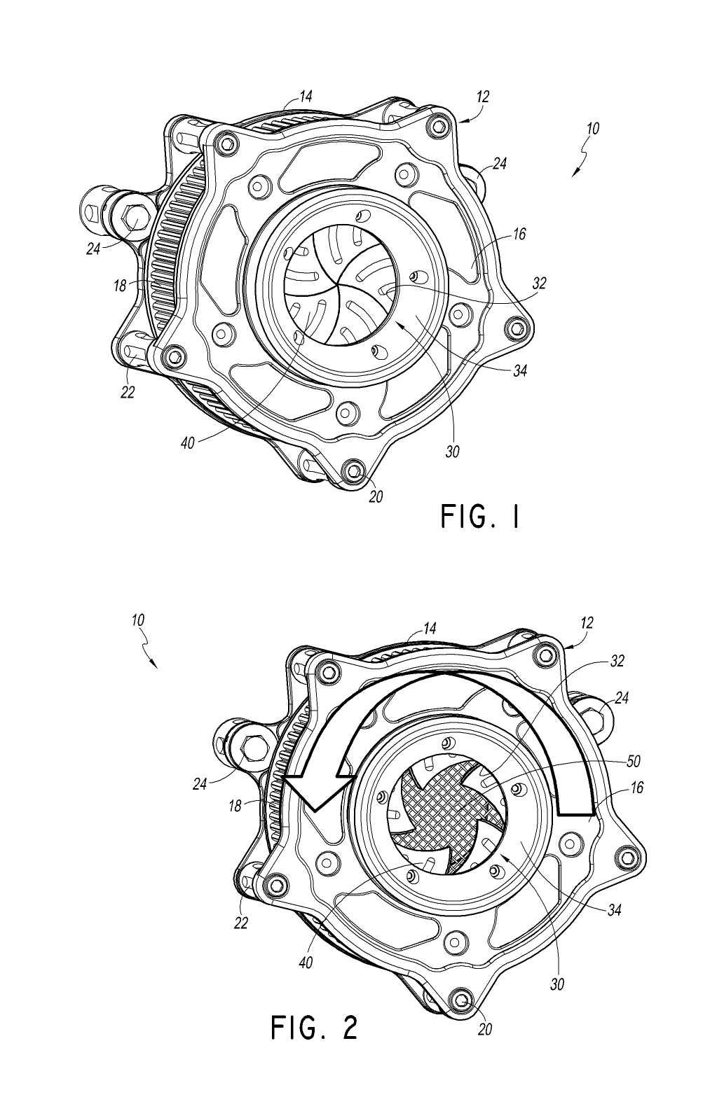

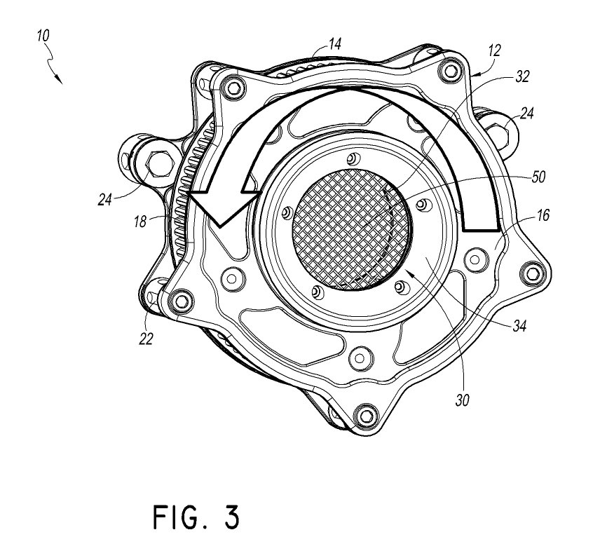

FIG. 1 illustrates the air filter system 10 in a first position, or normal use position, in which the shutter 40 is fully closed and preferably all intake air is required to pass through the filter element 18. As a result, maximum filtering preferably is provided. FIG. 2 illustrates the air filter system 10 in a second position in which the shutter 40 is partially open and some intake air is permitted to bypass the filter element 18 by passing through the bypass channel 30. As discussed herein, the shutter 40 can have multiple intermediate or partially opened positions. FIG. 3 illustrates the air filter system 10 in a third position in which the shutter 40 is in a fully opened position such that a maximum flow of intake air is permitted to bypass the filter element 18. When the bypass channel 30 is partially or fully open, a portion of the intake air preferably also passes through the filter element 18. However, depending on various factors, such as the amount of flow restriction provided by the filter element 18, the relative flow areas of the filter element 18 and the bypass channel 30 and the flow volume or velocity of the intake air flow (possibly among other factors), under some circumstances flow through the filter element 18 may be limited when the bypass channel 30 is partially or fully open.

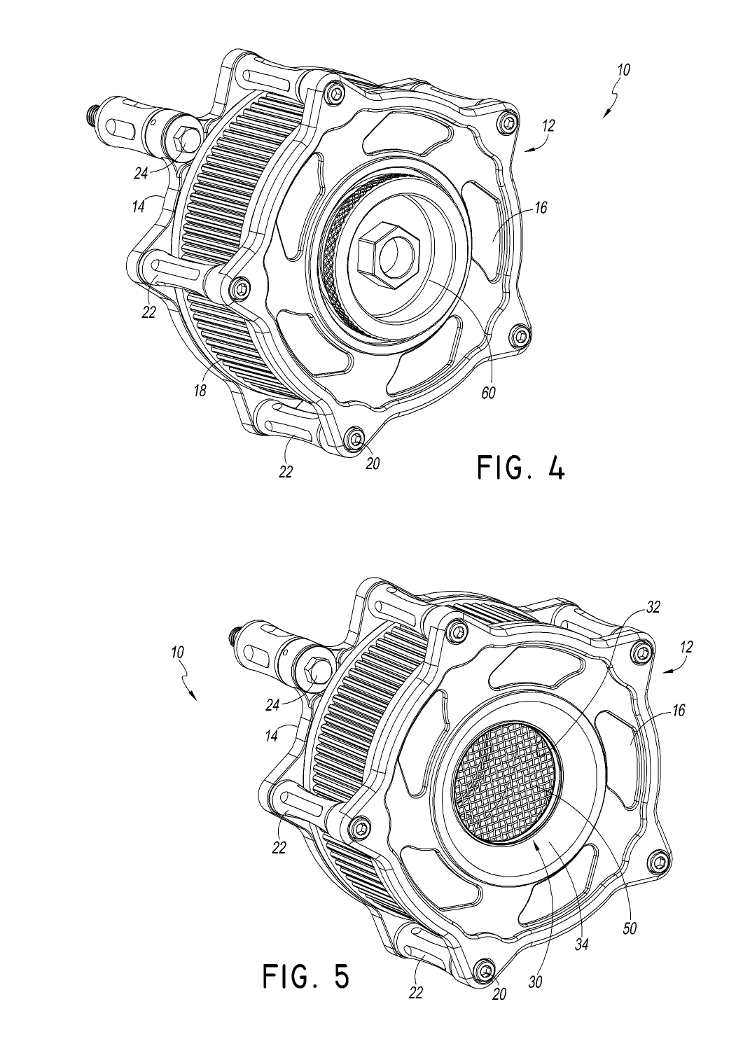

FIGS. 4 and 5 illustrate a modification of the air filter system 10 of FIGS. 1-3. In the air filter system 10 of FIGS. 4 and 5, the bypass channel 30 is closed by a removable plug 60. In some configurations, the plug 60 is threadably engaged with the opening 32 of the housing 16. The plug 60 can have a tool engagement portion, such as a nut-like structure or a tool cavity, to permit the plug 60 to be removable with a suitable tool. Alternatively, the plug 60 could be manually removable without the use of tools and could include a hand grip portion to facilitate such removal. In other arrangements, the plug 60 could be a friction fit or held in place with another component or arrangement, such as a latch, for example.

When the plug 60 is removed, a tapered inlet or velocity stack 34 can be coupled to the housing 16. Alternatively, the plug 60 could be positioned within the velocity stack 34, which could remain in place in both normal and bypass modes. The air filter system 10 of FIGS. 4 and 5 can be simpler in construction and, thus, can provide a lower cost alternative to the system 10 of FIGS. 1-3, while providing similar advantages.

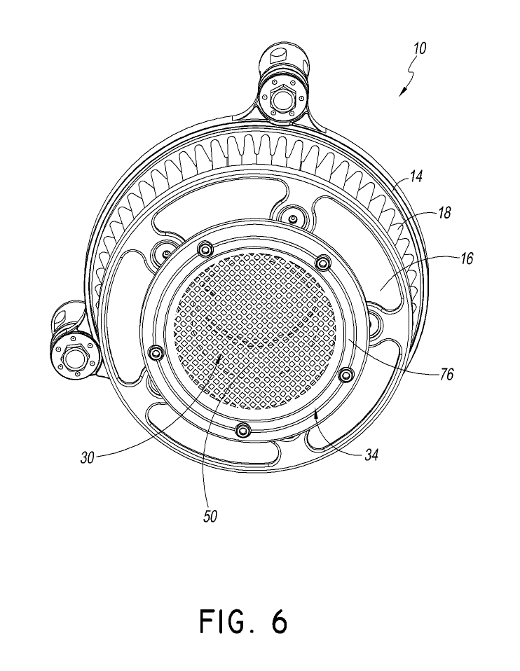

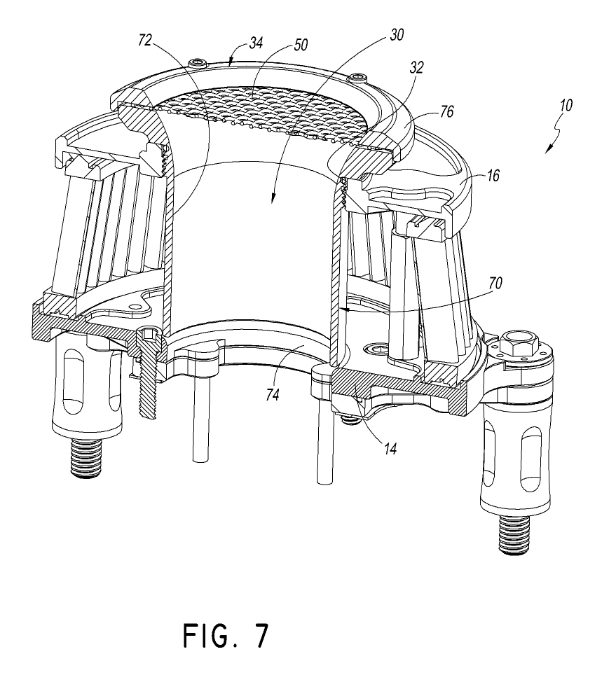

FIGS. 6 and 7 illustrate a modification of the air filter system 10 of FIGS. 4 and 5. The air filter system 10 of FIGS. 5 and 6 includes a bypass member 70 that defines at least a substantial entirety of the bypass channel 30. Preferably, the bypass member 70 includes a tubular portion 72 that extends from the opening 32 in the second plate 16 toward the first plate 14. Preferably, the tubular portion 72 extends the entire distance between the first plate 14 and the second plate 16 such that all of the intake air that passes through the opening 74 of the first plate 14 (and to the engine of the associated vehicle) passes through the tubular portion 72 of the bypass member 70. In other words, in some configurations, little to no intake air passes through the filter element 18 when the bypass member 70 is assembled to the air filter system 10 because the filter element 18 causes significantly greater resistance to air flow. However, in some configurations or under some circumstances, flow may be permitted to occur through both the bypass channel 30 and the filter element 18. In other arrangements, other suitable structures for channeling all intake flow through the bypass member 70 and/or substantially preventing intake flow through the filter element 18 in the bypass mode can also be used.

In the illustrated arrangement, an end of the tubular portion 72 abuts against a surface portion of the first plate 14 that surrounds the opening 74. Preferably, a diameter, cross-sectional dimension or area of the tubular portion 72 is the same as or substantially similar to the diameter, cross-sectional dimension or area of the opening 74 to provide good flow characteristics. It is contemplated that contact between the end of the tubular portion 72 and the surface of the first plate 14 sufficiently seals off the filter element 18 such that all or substantially all intake air is forced through the bypass member 70. However, in other arrangements, a separate seal member may be provided between the tubular portion 72 and the first plate 14.

In the illustrated arrangement, the bypass member 70 includes a tapered inlet or velocity stack 34, which can be coupled to or unitarily formed with the tubular portion 72, or a combination thereof. In the illustrated arrangement, a portion of the velocity stack 34 is unitarily formed with the tubular portion 72. A cap 76 is coupled to the end of the unitary portion of the velocity stack 34 and, preferably, secures the screen element 50 therebetween. The cap 76 can be coupled by any suitable arrangement, such as threaded fasteners (as shown), for example. In addition, the bypass member 70 can be coupled to the air filter system 10 by any suitable arrangement, such as threaded engagement with a component (e.g., the second plate 16) or any other arrangement described herein. A seal member (e.g., O-Ring) can be provided between the bypass member 70 and the component (e.g., the second plate 16), if desired. Similar to the system of FIGS. 4 and 5, the bypass member 70 can be removed and a plug (e.g., plug 60) can be used to plug the opening 32 for a filtered mode of the system 10.

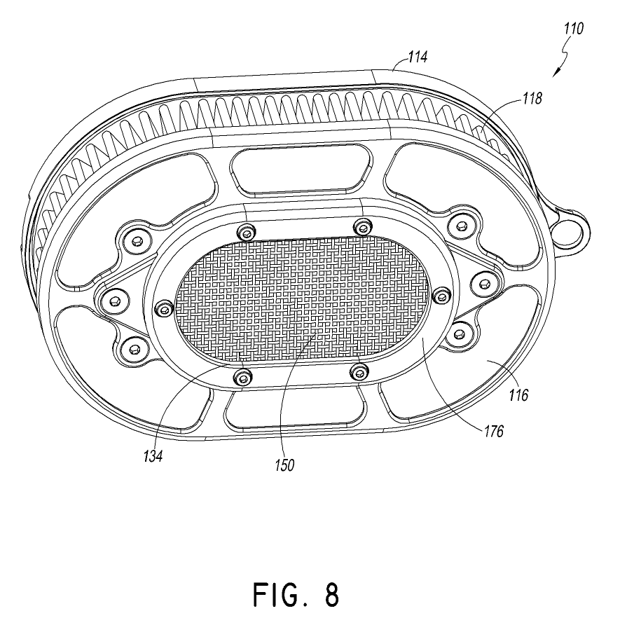

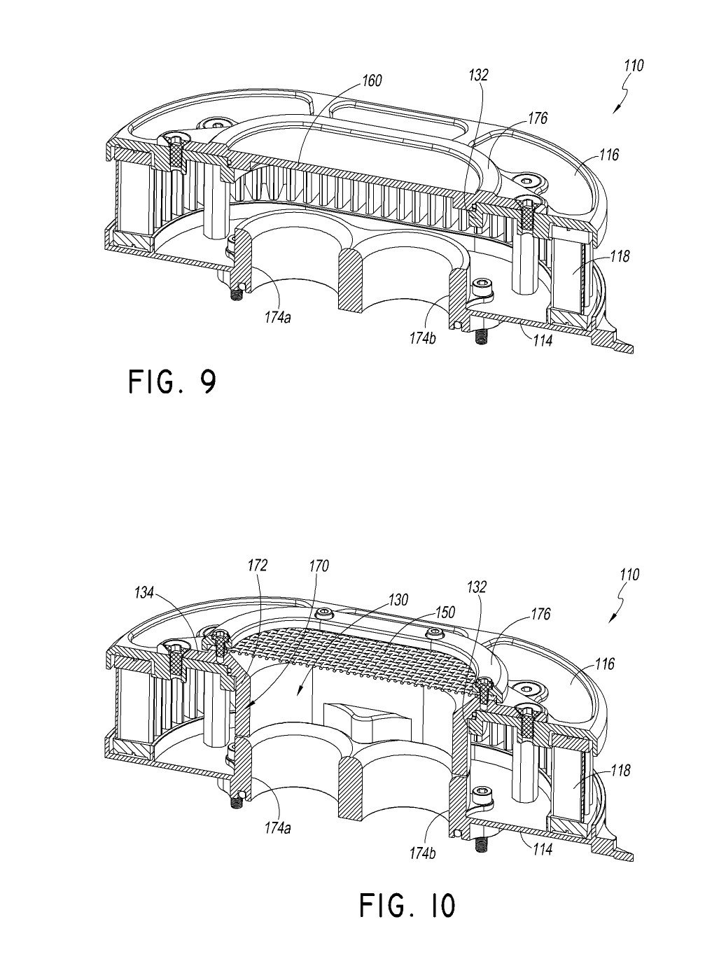

FIGS. 8-10 illustrate another embodiment of the air filter system 10 shown in FIGS. 6 and 7. The air filter system 110 shown in FIGS. 8-10 includes a filter mode (FIG. 9) and a bypass mode (FIG. 10). In the filter mode, the system 110 includes a plug or cover 160, which can be utilized to close off the opening 132 in the second plate 116 and force air flow through the filter element 118. In the bypass mode, the system 110 includes a bypass member 170 that defines at least a portion of the bypass channel 130. Preferably, the bypass member 170 can cooperate with portions or components of the first plate 114 and/or other portions of the system 110 to define an entirety or a substantially entirety of the bypass channel 130. In the illustrated arrangement, the bypass member 170 includes a singular intake channel or tubular portion 172 that communicates with one or more openings 174 of the first plate 114. Preferably, the tubular portion 172 and tubular intake ports 174a, 174b define a substantial entirety of the bypass channel 130 such that all of the intake air passing through the bypass channel 130 passes through the singular tubular portion 172 and one of the tubular intake ports 174a, 174b. In other words, in some configurations, little to no intake air passes through the filter element 118 when the bypass member 170 is assembled to the air filter system 110. In some configurations or under some circumstances, air flow may be permitted to occur through both the bypass arrangement 170 and the filter element 118. In other arrangements, other suitable structures for channeling all intake flow through the bypass member 170 and/or substantially preventing intake flow through the filter element 118 in the bypass mode can also be used.

Preferably, a total cross-sectional area of the singular tubular portion 172 is the same as or substantially similar to the collective cross-sectional area of the tubular intake ports 174a, 174b (or other configuration of the opening 174 in the first plate 114) to provide good flow characteristics. It is contemplated that contact between the end of the singular tubular portion 172 and the surface of the tubular intake ports 174a, 174b or other portion of the first plate 114 sufficiently seals off the filter element 118 such that all or substantially all intake air is forced through the bypass member 170. However, in other arrangements, a separate seal member may be provided between the singular tubular portion 172 and the tubular intake ports 174a, 174b or the first plate 114.

In the illustrated arrangement, the bypass member 170 includes a flange portion or flange 134, which can be coupled to or unitarily formed with the tubular portion 172, or a combination thereof. The flange 134 can permit the bypass member 170 to be secured to the second plate 116 by any suitable arrangement, such as one or more threaded fasteners (as shown), for example. A cap or ring 176 is coupled to the end of the flange 134 and, preferably, secures the screen element 150 therebetween. The ring 176 can be coupled to the flange 134, the second plate 116 or another suitable component by any suitable arrangement, such as threaded fasteners (as shown), for example. A seal member (e.g., O-Ring) can be provided between the bypass member 170 and the component (e.g., the second plate 116), if desired. The cover 160 and the flange 134 of the bypass member can be secured to the second plate 116 using the same fastener locations.

It should be noted that various changes and modifications to the presently preferred embodiments described herein will be apparent to those skilled in the art. Such changes and modifications may be made without departing from the spirit and scope of the invention and without diminishing its attendant advantages. For instance, various components may be repositioned as desired. It is therefore intended that such changes and modifications be included within the scope of the invention. Moreover, not all of the features, aspects and advantages are necessarily required to practice the present invention. Accordingly, the scope of the present invention is intended to be defined only by the claims.

What is claimed is:

1. An air filter system for a vehicle, comprising:
a housing defining an opening to an intake system of the vehicle;
a filter element supported within the housing and positioned upstream from the opening relative to a flow of intake air to the intake system;
a bypass channel that selectively permits intake air to pass through the opening without passing through the filter element; and
a closure that selectively closes the bypass channel.

2. The air filter system of claim 1, wherein the closure comprises a shutter.

3. The air filter system of claim 2, wherein the shutter is an iris-type shutter.

4. The air filter system of claim 2, wherein the shutter is variably adjustable between an opened position and a closed position.

5. The air filter system of claim 2, further comprising an intake member that surrounds an opening to the bypass channel.

6. The air filter system of claim 5, wherein the intake member is movable to adjust a position of the shutter.

7. The air filter system of claim 6, wherein the intake member is rotatable.

8. The air filter system of claim 1, wherein the closure comprises a plug.

9. The air filter system of claim 8, wherein when the plug is removed from an opening to the bypass channel, an intake member can be coupled to the opening.

10. The air filter system of claim 1, wherein the filter element is annular in shape and is sandwiched between a first plate and a second plate.

11. The air filter system of claim 10, wherein the bypass channel extends through the second plate and into an interior space of the filter element.

12. The air filter system of claim 1, further comprising a screen element extending across the bypass channel.

13. The air filter system of claim 1, further comprising a bypass member that defines a substantially entirety of the bypass channel such that all or substantially all intake air that passes through the air filter system passes through the bypass channel, without passing through the filter element, when the bypass member is in place.

14. An air filter system for a vehicle, comprising:
a housing defining an opening to an intake system of the vehicle;
a filter element supported within the housing and positioned upstream from the opening relative to a flow of intake air to the intake system;
a bypass channel that selectively permits intake air to pass through the opening without passing through the filter element, the bypass channel comprising a first bypass channel portion and a second bypass channel portion parallel to the first bypass channel portion, wherein the intake air passes through only one of the first and second bypass channel portions.

15. The air filter system of claim 14, further comprising a closure that selectively closes the bypass channel and forces the flow of intake air to pass through the filter element.

16. The air filter system of claim 14, further comprising an intake member that cooperates with the first and second bypass channel portions to define the bypass channel.

17. The air filter system of claim 14, further comprising a screen element extending across an opening to the bypass channel.
